(19) United States
(12) Patent Application Publication
(10) Pub. No.: US 2026/0203102 A1
(43) Pub. Date: Jul. 16, 2026

(54) DETERMINING TASK POOLS FOR DISPATCHING TASKS

(71) Applicant: INTERNATIONAL BUSINESS MACHINES CORPORATION, ARMONK, NY (US)

(72) Inventors: Lokesh Mohan Gupta, Tucson, AZ (US); Seamus J. BURKE, Tucson, AZ (US); Kevin J. Ash, Tucson, AZ (US); Kyler A. Anderson, Sahuarita, AZ (US)

(21) Appl. No.: 19/020,950

(22) Filed: Jan. 14, 2025

(51) Int. Cl. G06F 9/48; G06F 9/50

(52) U.S. Cl. CPC G06F 9/4881; G06F 9/5038

(57) ABSTRACT

Provided are a computer implemented method, system, and computer program product for determining task pools for dispatching tasks. Task pools of task resources are assigned to groups of tracks and to processors. Task resources allocated to a task are assigned from a task pool assigned the requested track. The task is processed by one of the processors assigned to the task pool. A determination is made of whether a least busy task pool having a lowest task resource allocation latency among the task pools satisfies a low latency criteria. A task, allocated from a source task pool, is determined that accesses tracks assigned to multiple task pools. The determined task is assigned to the least busy task pool in response to the least busy task pool satisfying the low latency criteria. The determined task is executed by a processor assigned to the least busy task pool.

### BACKGROUND OF THE INVENTION

### 1. Field of the Invention

The present invention relates to a computer implemented method, system, and computer program product for determining task pools for dispatching tasks.

### 2. Description of the Related Art

To synchronize access to a track in cache, a task seeking to obtain exclusive access to a track, such as for a stage or destage operation, needs to obtain a lock for the track, which grants the task access to the cache line having the track. Tasks seeking to access a track for which a lock is already granted, must wait for the lock to be released and granted in order to access the track. One lock technique is to provide a task a spinlock when requesting access to the track. A spinlock causes a task trying to acquire the lock to wait in a loop, i.e., “spin”, while repeatedly checking whether the lock is available. The task will hold the spinlock until the lock is available or until a time-out condition occurs.

Another locking technique is the use of a queue lock. With a queue lock, multiple tasks seeking to acquire the same lock spin on unique memory locations indicated in an array or queue. The queued requests for the lock are granted in a First-in-First-Out (FIFO) ordering.

### SUMMARY

Provided are a computer implemented method, system, and computer program product for determining task pools for dispatching tasks. Task pools of task resources are assigned to groups of tracks and to processors. Task resources allocated to a task to access a requested track are assigned from a task pool assigned to a group of tracks including the requested track. The task is processed by one of the processors assigned to the task pool. A determination is made of whether a least busy task pool having a lowest task resource allocation latency among the task pools satisfies a low latency criteria with respect to task resource allocation latencies of other task pools. A task, allocated task resources in a source task pool other than the least busy task pool, is determined that accesses tracks in multiple groups of tracks assigned to multiple task pools. The determined task and the task resources allocated to the determined task are assigned to the least busy task pool in response to the least busy task pool satisfying the low latency criteria. The determined task is executed by a processor assigned to the least busy task pool in response to reassigning the determined task to the least busy task pool.

### BRIEF DESCRIPTION OF THE DRAWINGS

FIG. 1 illustrates an embodiment of a computing environment.

FIG. 2 illustrates an embodiment of task pool information for a task pool from which task resources are allocated.

FIG. 3 illustrates an embodiment of lock information.

FIG. 4 illustrates an embodiment of a pool queue entry in a queue for a task pool in which requests for tracks are queued.

FIG. 5 illustrates an embodiment of pool queue performance information.

FIG. 6 illustrates an embodiment of operations to determine a least busy task pool.

FIG. 7 illustrates an embodiment of operations to dispatch a task requesting access to a track to a task pool.

FIG. 8 illustrates an embodiment of operations to reassign a task from a task pool to a least busy task pool.

FIG. 9 illustrates a computing environment in which the components of FIG. 1 may be implemented.

### DETAILED DESCRIPTION

In a multi-processor system where each processor has multiple cores, lock contention for tracks may proliferate from tasks executing in cores of different processors. To avoid lock contention among the multi-core processors seeking to access the same track, processors may be assigned to specific task pools where each task pool is associated with a storage rank. In this way, a task pool assigned to a rank manages the assignment of task resources and locks to tasks seeking to access a track in the assigned rank. This reduces contention because the locks are taken on the same task pool for a given rank.

One drawback to assigning ranks to specific task pools, is that if a host is executing numerous tasks directing request to certain ranks and not others, then the task pools assigned lightly accessed ranks will be idle and task pools assigned heavily accessed ranks will have a heavy load resulting in long dispatch times and lengthy queues. Such load balance disparities result in low performance at the heavily used task pools.

Described embodiments provide improvements to task dispatching technology by dispatching tasks, which do not benefit from being in a task pool specific to a specific rank or group of tracks, to a less used task pool. For instance, tasks that access tracks across ranks may not benefit from being limited to a task pool for a specific rank. Described embodiments provide techniques to dispatch such tasks to less busy task pools. Further described embodiments provide techniques to dynamically reassign tasks from heavily used task pools to less used task pools to perform load balancing among the task pools and improve performance at the task pools assigned to ranks that include frequently accessed tracks.

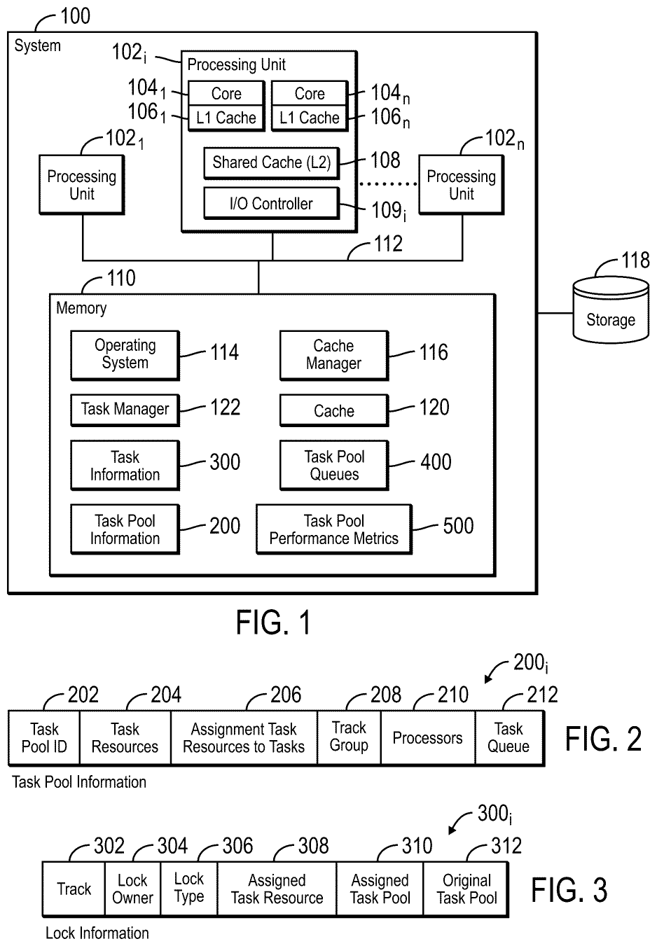

FIG. 1 illustrates an embodiment of a system 100 including a plurality of processing units 102₁, 102ᵢ . . . 102ₙ. Processing unit 102ᵢ refers to any one of the processing units 102₁. . . 102ₙ or multiple of the processing units. Processing unit(s) 102 may refer to any one or more of the processors 102ᵢ. Each of the processing units 102ᵢ may include a plurality of cores 104₁ . . . 104ₙ on a single integrated circuit substrate, i.e., chip. Each core 104₁ . . . 104 has an L1 cache 106₁ . . . 106ₙ. The cores 104₁ . . . 104ₙ share a shared cache (L2) 108. An Input/Output (I/O) controller 109ᵢ includes the components to communicate with I/O devices, such as a memory 110, a bus interface 112, video controller, network cards, and any other I/O devices. The I/O controller 109ᵢ may comprise the processing unit 102ᵢ chipset. There may be further levels of caches, such as additional cache levels within the processing units 102ᵢ.

The main memory 110 includes an operating system 114 and a cache manager 116 to manage tracks in a storage 118 maintained in cache 120. A track comprises a unit of storage, including a logical block address (LBA), track or other accessible storage unit that may exist in cache 120 or storage 118. A task manager 122, which may also be considered a lock manager, maintains locks for tracks from storage 118 in the cache 120. The task manager 122 maintains task pool information 200 for task pools of task resources to assign to tasks. A task pool information instance 200ᵢ, as shown in FIG. 2, may indicate: a task pool identifier 202; tasks resources 204 to assign to tasks; an assignment 206 of task resources in the pool 202 to tasks; a track group 208 of tracks assigned to the task pool 202; processors 210 indicating processors 102 assigned to process tasks allocated task resources 204 from the task pool 202; and a task queue 212 to queue requests tracks while waiting for the lock held for a requested track to be freed.

A task resource is a dispatchable unit of work, including status, flags, registers to manage and track information pertinent to execution of a task, such as a thread or process, at a processor 102. A task resource, in certain embodiments, may comprise a task control block (TCB), process control block (PCB), process descriptor, thread control block (TCB) , thread environment block (TEB), etc. A track group 208 may comprise a rank when the storage 118 comprises an array of storage devices, such as a Redundant Array of Independent Disks (RAID) array, Just a Bunch of Disk (JBOD), etc. The track group 208 may comprise other logical or physical groupings of tracks or data units, such as volumes, logical disks, etc.

A processor as that term is used herein may refer to a processing unit 102ᵢ, a core 104ᵢ or any other processing element.

The task manager 122 further maintains lock information 300 having lock information instances 300ᵢ on granted locks for tracks. As shown in FIG. 3, the lock information instance 300ᵢ may indicate: a track 302 in the cache 120 subject to a lock, a lock owner 304 of the task holding the lock, a lock type 306, such as exclusive, non-exclusive, shared, etc., an assigned task resource 308 holding the lock to access the track 302, an assigned task pool 310 to which the task resource 308 is currently assigned, and an original task pool 312 from which the task resource 308 was originally allocated.

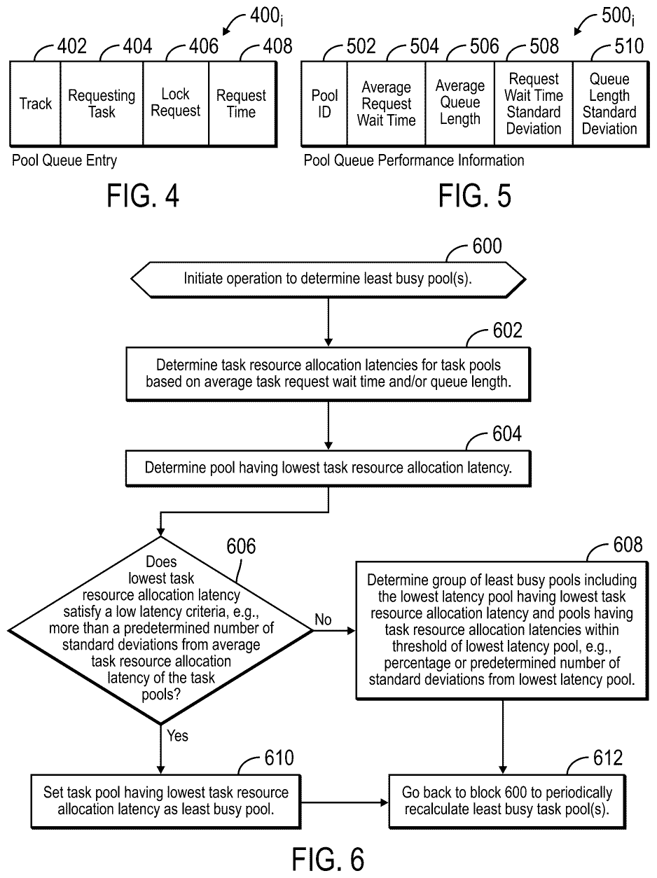

Task pools have queues 400 to queue track requests. There may be one or more queues dedicated to each task pool. As shown in FIG. 4, an entry 400ᵢ in a queue for a task pool may indicate a requested track 402, the requesting task 404 requesting access to the track 402, a lock request 406 indicating a type of the lock requested for the track 402, and a request time 408. The request time may be used to determine how long requests have waited to be granted task resources from the task pool to access the requested track.

The task manager 122 may further collect task pool performance metrics 500 for each task pool. As shown in FIG. 5, the performance metrics 500ᵢ for a task pool may include: a pool ID 502 indicating the pool for which metrics are gathered; an average request wait time 504 requests wait in a queue 400 for the task pool for a measurement period; an average queue length 506 for the measurement period; a request wait time standard deviation 508 from the average; and a queue length standard deviation 510.

The L1 cache 106ᵢ and shared cache 108 may comprise a high-speed data storage layer which stores a subset of cache lines in the main memory 110 cache 116. The cache and shared cache are typically transient in nature, so that future requests for that data are served up faster than is possible by accessing the primary storage location of the data. The L1 cache 106ᵢ, shared cache 108, and memory 110 may comprise a volatile or non-volatile memory device, such as a Static Random Access Memory (SRAM), Dynamic Random Access Memory (DRAM), eDRAM (embedded DRAM). Other embodiments may utilize phase change memory (PCM), Magnetoresistive random-access memory (MRAM), Spin Transfer Torque (STT)-MRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

The storage 118 may comprise one or more storage devices, such as

hard disk drives, solid state drives (SSDs), and other types of storage devices. The storage devices comprising the storage 118 may be configured into an

array of devices, such as Just a Bunch of Disks (JBOD), Direct Access Storage Device

(DASD), Redundant Array of Independent Disks (RAID) array, virtualization device, etc.

Further, the storage devices may comprise heterogeneous storage devices from different

vendors or from the same vendor. A collection of physical storage arrays may be further combined to form a rank, which dissociates the physical storage from the logical configuration. The storage space in a rank may be allocated into logical volumes, which define the storage location specified in a write/read request.

A task that requests task resources/locks may be implemented in code executed by the processing unit 102 cores 104.

In FIG. 1, the processing units are shown as multi-core processing units. In alternative embodiments, the processing units may comprise a single core processor. In described embodiments, the I/O controller 109ᵢ is shown as implemented on the processing unit 102ᵢ, such as with a system-on-a-chip implementation. In alternative embodiments, the I/O controller 109ᵢ may be maintained in a separate chipset for the processing unit 102ᵢ.

Generally, program modules, such as the program components 114, 116, 122, among others, may comprise routines, programs, objects, components, logic, data structures, and so on that perform particular tasks or implement particular abstract data types. The program components and hardware devices of the system 100 may be implemented in one or more storage systems or computer systems, where if they are implemented in multiple storage systems or computer systems, then the storage systems or computer systems may communicate over a network or a bus.

The program components 114, 116, 122, among others, may be accessed by a processor from memory to execute. Alternatively, some or all of the program components 114, 116, 122, among others, may be implemented in separate hardware devices, such as Application Specific Integrated Circuit (ASIC) hardware devices or a Field Programmable Gate Array (FPGA).

FIG. 6 illustrates an embodiment of operations performed by the task manager, such as task manager 122, to determine one or more least busy pools to load balance the assignment or reassignment of tasks to task pools. Upon initiating (at block 600) an operation to determine one or more least busy task pools, the task manager determines (at block 602) task resource allocation latencies for the task pools. A task resource allocation latency indicates a delay in assigning task resources in a task pool to tasks accessing a track assigned to the task pool. The task resource allocation latency may be based on an average task request wait time in a queue of the task pool and/or queue length of the task pool queue. In further embodiments, the task resource allocation latency for a task pool may comprise a metric or score based on a function including the average task request wait time in the queue for the task pool and the queue length for the task pool.

The task manager determines (at block 604) a task pool having a lowest task resource allocation latency. The task manager may further determine (at block 606) if the lowest task resource allocation latency satisfies a low latency criteria. The low latency criteria may be satisfied if the lowest task resource allocation latency differs from an average task resource allocation latency for all the task pools by at least a threshold. In certain embodiments, the threshold may comprise a number of standard deviations from the average task resource allocation latency or a threshold percentage difference from the average.

If (at block 606) the lowest task resource allocation latency satisfies the low latency criteria, then the task pool having the lowest task resource allocation latency is set (at block 610) as the least busy task pool. Otherwise, if (at block 606) the lowest task resource allocation latency does not satisfy the low latency criteria, then a group of least busy pools is determined (at block 608) including the pool having lowest task resource allocation latency and any pools having task resource allocation latencies within predetermined number of standard deviations from lowest latency. From block 608 or 610 control may periodically return (at block 612) to block 600 to recalculate the least busy task pool.

With the embodiment of FIG. 6, one or more lowest task resource allocation latency pools are determined. The lowest latency task pool may be used to reassign tasks assigned task resources from a heavily used task pool with a high latency for load balancing of tasks across task pools and processor resources. Further, least busy task pool(s) may be used for initially dispatching of a received task.

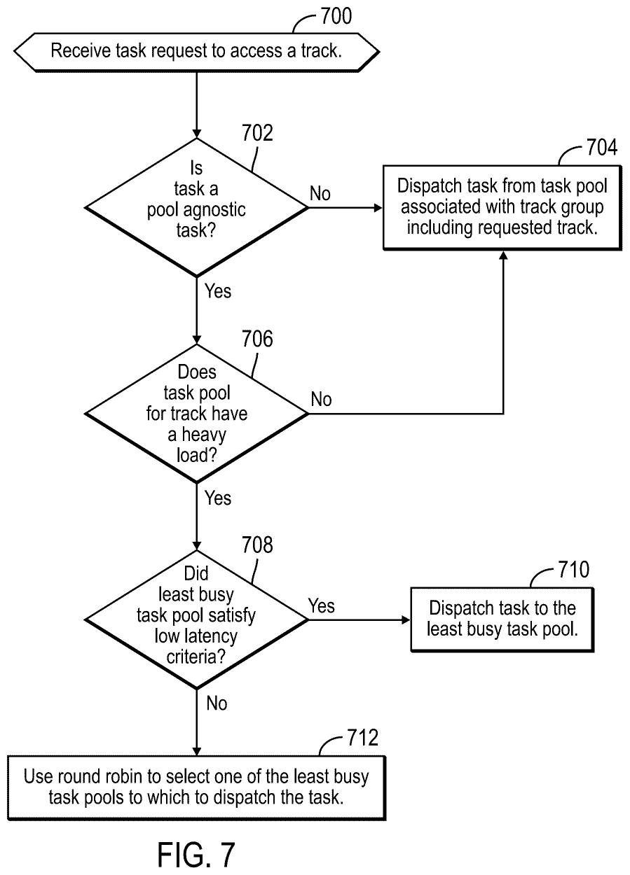

FIG. 7 illustrates an embodiment of operations performed by the task manager to determine a task pool to which to dispatch a task request to access a track. Upon receiving (at block 700) a task request to access a track, the task manager determines (at block 702) whether the requesting task is task pool agnostic. A task is defined as task pool agnostic when the task is not limited to accessing tracks assigned just to one task pool, runs as a background task, and/or would not benefit from running in a specific task pool. For instance, task pool agnostic tasks may include tasks that run as background tasks, tasks that are not limited to accessing locks associated with only one task pool, demote scan tasks that demote tracks from Least Recently Used partitions, cache scan tasks, tasks that access tracks unlikely to be used by other processes, and copy service tasks that access tracks in multiple track groups assigned to different task pools.

If (at block 702) the requesting task is task pool agnostic, then the task manager determines (at block 706) whether the task pool assigned the track group including the requested track has a heavy load. A task pool may have a heavy load when its current task resource allocation latency exceeds the average latency by some predetermined number of standard deviations or other threshold. If (from the NO branch of block 702) the task is not task pool agnostic, i.e., access tracks in a track group assigned to one pool, or if (from the NO branch of block 706) the task pool for the track does not have a heavy load, then the task manager dispatches (at block 704) the task to the task pool associated with the track group including the track requested by the task. A task dispatched to a task pool is allocated task resources from the task pool to access the requested track if a lock is not already held for the requested track. If a lock is already held or no task resources in the task pool are available for allocation, then the task is added to a queue for the task pool to wait for the lock to the track to be released or task resources to become available so task resources may be allocated to the task to access the requested track.

If (at block 706) the task pool for the track does have a heavy load, a determination is made (at block 708) if the least busy task pool satisfied the low latency criteria. If so, then then the task is dispatched (at block 710) to the least busy task pool. If (at block 708) the low latency criteria was not satisfied and there are multiple least busy task pools, then the task manager may use (at block 712) a round robin or other selection algorithm to select one of the least busy task pools to which to dispatch the task. In this way, a task pool agnostic task requesting to access a track and not yet dispatched to a task pool is dispatched to a least busy task pool to provide load balancing in the assignment of tasks to task pools.

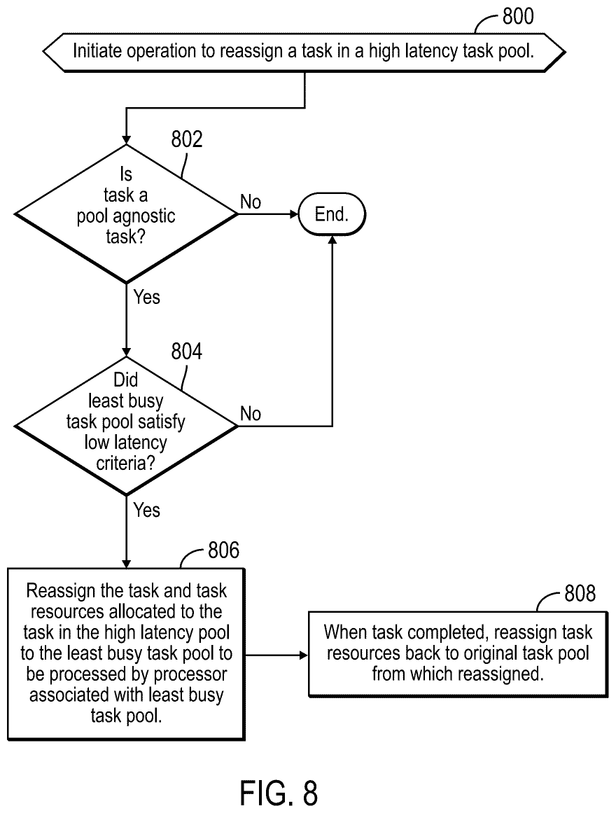

FIG. 8 illustrates an embodiment of operations to determine whether to reassign a task presently allocated task resources from a high latency task pool to a low latency task pool to provide dynamic load balancing of already allocated task resources. Upon initiating (at block 800) an operation to reassign a task resource already allocated to a high latency task pool, a determination is made (at block 802) whether the task being considered is task pool agnostic. If so, then a determination is made (at block 804) whether the least busy task pool satisfies the low latency criteria. If (from the NO branch of block 802) the considered task is not task pool agnostic or if (from the NO branch of block 804) the low latency criteria was not satisfied, control ends. Otherwise, if the low latency criteria was satisfied, then the task and task resources allocated to the task in the high latency pool are reassigned (at block 806) to the least busy task pool to be processed by a processor associated with least busy task pool. When the reassigned task completes (at block 808), the task resources allocated to the task may be reassigned back to the original task pool from which the task was reassigned.

With the embodiment of operations of FIG. 8, dynamic load balancing is performed for tasks already dispatched to a high latency task pool to reassign to a least busy task pool to reduce the burdens and wait times for tasks that need to be processed at the high latency task pool, such as tasks that are not task pool agnostic. Such non-agnostic tasks may comprise tasks that only access tracks assigned to a particular task pool.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

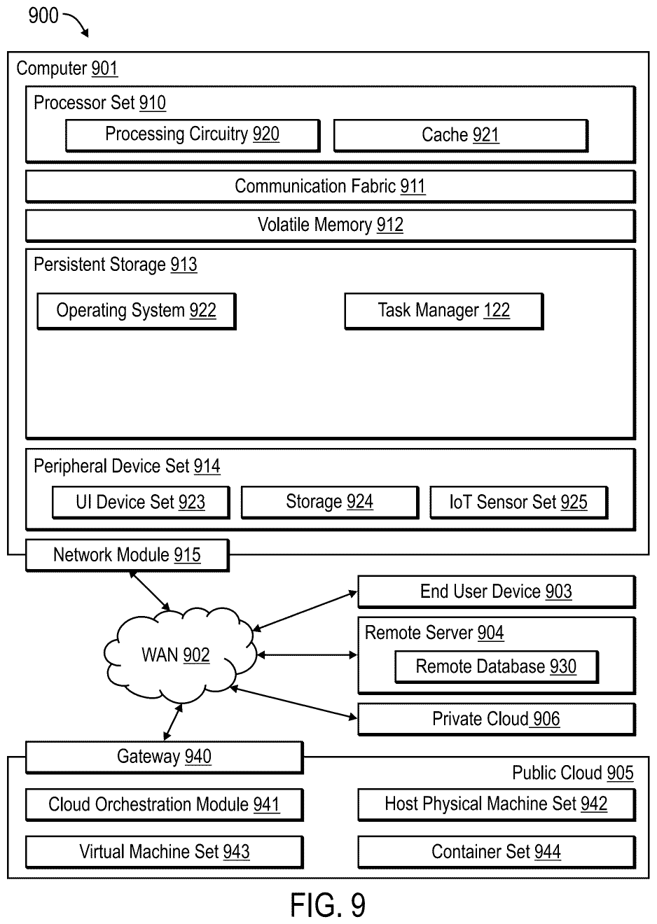

With respect to FIG. 9, computing environment 900 contains an example of an environment for the execution of at least some of the computer code involved in performing the inventive methods, such as the task manager 122. In addition, the computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and task manager 122, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer-readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 921 and the other storage media discussed below. The program instructions, and associated data, are accessed by processor set 910 to control and direct performance of the inventive methods. In computing environment 900, at least some of the instructions for performing the inventive methods, including, but not limited to, the task manager 122, may be stored in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code for the task manager 122 and other components typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer-readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

CLOUD COMPUTING SERVICES AND/OR MICROSERVICES (not separately shown in FIG. 9): private and public clouds 906 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for managing locks to tracks from storage cached in memory, comprising:
providing task pools of task resources assigned to groups of tracks and to processors, wherein task resources allocated to a task to access a requested track are assigned from a task pool assigned to a group of tracks including the requested track, wherein the task is processed by one of the processors assigned to the task pool;
determining whether a least busy task pool having a lowest task resource allocation latency among the task pools satisfies a low latency criteria with respect to task resource allocation latencies of other task pools;
determining a task, allocated task resources in a source task pool other than the least busy task pool, that accesses tracks in multiple groups of tracks assigned to multiple task pools;
reassigning the determined task and the task resources allocated to the determined task to the least busy task pool in response to the least busy task pool satisfying the low latency criteria; and
executing the determined task by a processor assigned to the least busy task pool in response to reassigning the determined task to the least busy task pool.

2. The computer implemented method of claim 1, further comprising:
completing the determined task; and
reassigning the task resources reassigned to the least busy task pool back to the source task pool to be available in the source task pool for allocation to further tasks.

3. The computer implemented method of claim 1, wherein the determined task is selected from the group consisting of tasks that run in background, tasks that are not limited to accessing locks associated with only one task pool, demote scans that demote tracks from Least Recently Used partitions, cache scans, tasks that access tracks unlikely to be used by other processes, and copy services that access tracks in multiple groups to copy.

4. The computer implemented method of claim 1, wherein a task resource allocation latency comprises an average wait time at a task pool, wherein the low latency criteria is satisfied if the average wait time at the least busy task pool differs from an average wait time for all the task pools by a threshold.

5. The computer implemented method of claim 1, wherein each task pool has a queue in which requests for task resources are queued, wherein a task resource allocation latency comprises a queue length of the queue for the task pool, wherein the low latency criteria is satisfied if the queue length at the least busy task pool differs from an average queue length for all the task pools by a threshold.

6. The computer implemented method of claim 1, wherein each task pool has a queue in which requests for task resources are queued, wherein a task resource allocation latency comprises a metric based on a combination of a queue length and an average wait time for a task resource to be allocated to a task, wherein the low latency criteria is satisfied if the metric at the least busy task pool differs from an average metric for all the task pools by a threshold.

7. The computer implemented method of claim 1, wherein the low latency criteria is satisfied when the least busy task pool has a task resource allocation latency more than a predetermined number of standard deviations below an average task resource allocation latency of the task pools.

8. The computer implemented method of claim 1, wherein the requested track comprises a first track, and wherein the task comprises a first task, further comprising:
receiving a request for a second track from a second task that accesses tracks in multiple groups of tracks assigned to multiple task pools;
determining a plurality of least busy task pools including the least busy task pool and task pools having a task resource allocation latency within a threshold from the task resource allocation latency of the least busy task pool in response to the least busy task pool not satisfying the low latency criteria; and
using a round robin selection method to select one of the least busy task pools; and
dispatching the second task to the selected one of the least busy task pools.

9. The computer implemented method of claim 1, wherein the requested track comprises a first track and the task comprises a first task, further comprising:
receiving a request for a second track from a second task that accesses tracks in multiple groups of tracks assigned to multiple task pools; and
dispatching the second task to the least busy task pool in response to the least busy task pool satisfying the low latency criteria.

10. A computer system for managing locks to tracks from storage cached in memory, comprising:
a processor set;
one or more computer-readable storage media; and
program instructions stored on the one or more computer-readable storage media to cause the processor set to perform operations comprising:
providing task pools of task resources assigned to groups of tracks and to processors, wherein task resources allocated to a task to access a requested track are assigned from a task pool assigned to a group of tracks including the requested track, wherein the task is processed by one of the processors assigned to the task pool;
determining whether a least busy task pool having a lowest task resource allocation latency among the task pools satisfies a low latency criteria with respect to task resource allocation latencies of other task pools;
determining a task, allocated task resources in a source task pool other than the least busy task pool, that accesses tracks in multiple groups of tracks assigned to multiple task pools;
reassigning the determined task and the task resources allocated to the determined task to the least busy task pool in response to the least busy task pool satisfying the low latency criteria; and
executing the determined task by a processor assigned to the least busy task pool in response to reassigning the determined task to the least busy task pool.

11. The computer system of claim 10, wherein the operations further comprise:
completing the determined task; and
reassigning the task resources reassigned to the least busy task pool back to the source task pool to be available in the source task pool for allocation to further tasks.

12. The computer system of claim 10, wherein a task resource allocation latency comprises an average wait time at a task pool, wherein the low latency criteria is satisfied if the average wait time at the least busy task pool differs from an average wait time for all the task pools by a threshold.

13. The computer system of claim 10, wherein each task pool has a queue in which requests for task resources are queued, wherein a task resource allocation latency comprises a queue length of the queue for the task pool, wherein the low latency criteria is satisfied if the queue length at the least busy task pool differs from an average queue length for all the task pools by a threshold.

14. The computer system of claim 10, wherein the requested track comprises a first track, and wherein the task comprises a first task, wherein the operations further comprise:
receiving a request for a second track from a second task that accesses tracks in multiple groups of tracks assigned to multiple task pools;
determining a plurality of least busy task pools including the least busy task pool and task pools having a task resource allocation latency within a threshold from the task resource allocation latency of the least busy task pool in response to the least busy task pool not satisfying the low latency criteria;
using a round robin selection method to select one of the least busy task pools; and
dispatching the second task to the selected one of the least busy task pools.

15. The computer system of claim 10, wherein the requested track comprises a first track and the task comprises a first task, wherein the operations further comprise:
receiving a request for a second track from a second task that accesses tracks in multiple groups of tracks assigned to multiple task pools; and
dispatching the second task to the least busy task pool in response to the least busy task pool satisfying the low latency criteria.

16. A computer program product for managing locks to tracks from storage cached in memory, comprising:
one or more computer-readable storage media; and
program instructions stored on the one or more computer-readable storage media to perform operations comprising:
providing task pools of task resources assigned to groups of tracks and to processors, wherein task resources allocated to a task to access a requested track are assigned from a task pool assigned to a group of tracks including the requested track, wherein the task is processed by one of the processors assigned to the task pool;
determining whether a least busy task pool having a lowest task resource allocation latency among the task pools satisfies a low latency criteria with respect to task resource allocation latencies of other task pools;
determining a task, allocated task resources in a source task pool other than the least busy task pool, that accesses tracks in multiple groups of tracks assigned to multiple task pools;
reassigning the determined task and the task resources allocated to the determined task to the least busy task pool in response to the least busy task pool satisfying the low latency criteria; and
executing the determined task by a processor assigned to the least busy task pool in response to reassigning the determined task to the least busy task pool.

17. The computer program product of claim 16, wherein the operations further comprise:
completing the determined task; and
reassigning the task resources reassigned to the least busy task pool back to the source task pool to be available in the source task pool for allocation to further tasks.

18. The computer program product of claim 16, wherein a task resource allocation latency comprises an average wait time at a task pool, wherein the low latency criteria is satisfied if the average wait time at the least busy task pool differs from an average wait time for all the task pools by a threshold.

19. The computer program product of claim 16, wherein each task pool has a queue in which requests for task resources are queued, wherein a task resource allocation latency comprises a queue length of the queue for the task pool, wherein the low latency criteria is satisfied if the queue length at the least busy task pool differs from an average queue length for all the task pools by a threshold.

20. The computer program product of claim 16, wherein the requested track comprises a first track, and wherein the task comprises a first task, wherein the operations further comprise:
receiving a request for a second track from a second task that accesses tracks in multiple groups of tracks assigned to multiple task pools;
determining a plurality of least busy task pools including the least busy task pool and task pools having a task resource allocation latency within a threshold from the task resource allocation latency of the least busy task pool in response to the least busy task pool not satisfying the low latency criteria;
using a round robin selection method to select one of the least busy task pools; and
dispatching the second task to the selected one of the least busy task pools.
